(19) United States
(12) Patent Application Publication
(10) Pub. No.: US 2010/0079929 A1
(43) Pub. Date: Apr. 1, 2010

(54) CMOS COMPATIBLE INTEGRATED HIGH DENSITY CAPACITOR STRUCTURE AND PROCESS SEQUENCE

(76) Inventors: Peter Smeys, Mountain View, CA (US); Peter Johnson, Sunnyvale, CA (US)

Correspondence Address: Dergosits & Noah LLP (NSC);Counsel for National Semiconductor Corporation, Three Embarcadero Center, Suite 410, San Francisco, CA, 94111, US

(21) Appl. No.: 12/243,123

(22) Filed: Oct. 1, 2008

(51) Int. Cl. H01G 9/07; H01G 9/00

(52) U.S. Cl. 361/524; 29/25.03

(57) ABSTRACT

Integrated circuits structures and process sequences are provided for forming CMOS compatible high-density capacitors. The anodization of tantalum to tantalum oxide in the formation of the inter-plate capacitor dielectric results in very high dielectric constants since the defects usually found in the inter-plate dielectric are eliminated in the volume expansion that occurs during the oxidation of the tantalum material. This permits the fabrication of larger capacitors that can be incorporated into standard CMOS process flows.

### FIELD OF THE INVENTION

The present invention relates to integrated circuits and, in particular, to structures and methods for integrating high density capacitor structures into a conventional CMOS integrated circuit process flow utilizing tantalum (Ta) anodization techniques.

### BACKGROUND OF THE INVENTION

Capacitor structures utilized in currently available CMOS integrated circuits are typically polysilicon-insulator-polysilicon or metal-insulator-metal capacitors that are integrated with standard metallization technology and utilize SiN or SiO₂ as the capacitor dielectric. Typical capacitance densities achievable in standard analog processes utilizing these technologies are of the order of 1 fF/μm². Higher capacitance densities can only be achieved by increasing the surface area of the capacitor and/or by increasing the dielectric constant of the material used. The increase of area density is typically achieved by forming a trench and is limited by the maximum depth of the trench achievable in a CMOS intermetal dielectric. Efforts to achieve higher capacitance densities by increasing the dielectric constant are limited to the availability of known, thermally stable materials and by the defect densities that occur in the larger structures. Defects in the dielectrics will result in performance degrading leakage current.

### SUMMARY OF THE INVENTION

The present invention provides a structure and process sequence for providing CMOS compatible high density capacitors. Utilizing the anodization of tantalum to tantalum oxide in the formation of the capacitor dielectric results in very high dielectric constants since the defects usually found in the capacitor dielectric in larger capacitors are substantially removed in the volume expansion that occurs during tantalum oxidation. This permits the fabrication of larger capacitors that can be incorporated into standard CMOS process flows and that exhibit capacitance densities of up to 6 fF/μm².

The features and advantages of the various aspects of the present invention will be more fully understood and appreciated upon consideration of the following detailed description of the invention and the accompanying drawings, which set forth illustrative embodiments in which the concepts of the invention are utilized.

### BRIEF DESCRIPTION OF THE DRAWINGS

FIGS. 1-6 are cross-section drawings illustrating a sequence of integrated circuit process steps for fabricating an embodiment of a high density capacitor structure in accordance with the concepts of the present invention.

FIG. 7 is a cross-section drawing illustrating an alternate embodiment of a high density capacitor structure in accordance with the concepts of the present invention.

### DETAILED DESCRIPTION OF THE INVENTION

The following detailed description of the present invention sets forth embodiments for fabricating high-density capacitor structures in accordance with the concepts of the invention. These embodiments of the invention are described utilizing specific material thicknesses. However, those skilled in the art should appreciate that these specific thicknesses are not to be considered limiting of the concepts of the present invention, but rather as being illustrative. Those skilled in the art will further appreciate that the thicknesses associated with any particular high-density capacitor structure in accordance with the concepts of the present invention will be dependent upon the particular integrated circuit application in which the capacitor structure is utilized.

The concepts of the invention are also described in the context of process modules for achieving desired structures. Those skilled in the art will appreciate that these process modules are well know to conventional CMOS processing.

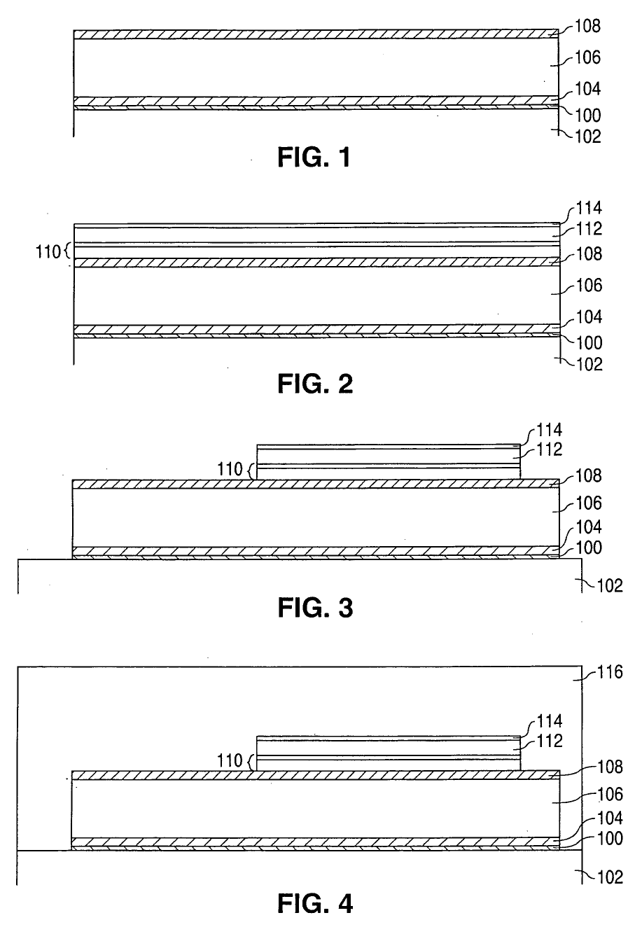

FIGS. 1-6 show a sequence of process steps for fabricating a “single dielectric layer” embodiment of a high-density capacitor structure in accordance with the concepts of the invention. As stated above, the process modules utilized in fabricating the high-density capacitor structure are typically found in standard CMOS process technology.

FIG. 1 shows the formation of the bottom capacitor plate which is a typical metal interconnect stack. The stack includes a titanium (Ti) layer 100 about 100 Å thick on an underlying layer of dielectric material 102, as typically found in a CMOS device structure. A titanium nitride (TiN) layer 104 about 200 Å thick is formed on the underlying titanium layer 100. This is followed by the formation of an aluminum/copper (AlCu) layer 106 about 4500 Å thick on the titanium nitride layer 104. 250 Å of titanium nitride 108 is then formed on the aluminum/copper layer 106. These layers complete the interconnect stack. As described in detail below, the patterning of these layers will result in the definition of a capacitor bottom metal plate.

Referring to FIG. 2, a tantalum (Ta) layer is then formed over the upper titanium nitride layer 108 of the “pre” capacitor bottom metal plate structure. The tantalum layer is about 1000 Å thick and is reactively sputtered in an Argon plus Nitrogen ambient. The sputtering ambient includes about 10-20% nitrogen, thereby forming a TaN layer to facilitate the creation of the appropriate dielectric constant and leakage current for the particular circuit application. Next, an anodization step is performed to convert at least an upper portion of the tantalum (TaN) to tantalum oxide, typically Ta₂O₅. The anodization step can be performed in a typical electroplating system using citric acid (˜0.1 g/liter) electrolyte. The selection of the anodization voltage and current will determine a self-limiting thickness for the oxidized TaN film. Typically a 400 Å thick Ta₂O₅ layer is formed on the TaN, resulting in a Ta₂O₅/TaN stack. The result is a tantalum (nitrogen) and tantalum oxide layer 110 about 1200 Å thick. As describe in detail below, the patterning of this TaN+TaO layer results in the definition of a capacitor inter-plate dielectric material.

Next, as further shown in FIG. 2, an aluminum/copper layer 112 about 1500 Å thick is deposited followed by the formation of a titanium nitride layer 114 about 700 Å thick on the aluminum/copper layer 112. This metal stack will serve as the top plate of the capacitor. It may be beneficial to include a thin Ta layer under the AlCu layer.

FIG. 3 shows the structure resulting from the photolithography based patterning and etching of the foregoing structure to define the capacitor top metal plate, the capacitor inter-plate dielectric and the capacitor bottom metal plate of this embodiment of a high density capacitor structure.

The capacitor top metal plate and the capacitor inter-metal dielectric are patterned utilizing a two-masking step etch process. After defining the top capacitor plate with a photoresist mask, the titanium nitride layer 114 and underlying aluminum/copper layer 112 are plasma etched, stopping in the tantalum oxide 110, thereby defining the capacitor top metal plate. At this point, a second photoresist mask is used to define the bottom capacitor plate and the associated interconnect layer. The first step of the subsequent plasma etch patterns the tantalum oxide layer 110 to define the capacitor inter-layer dielectric, which, as discussed above includes the anodized tantalum oxide. This is followed by a second plasma etch to pattern the remaining tantalum nitride layer 110, titanium nitride layer 108, aluminum/copper layer 106, titanium nitride layer 104 and underlying titanium layer 100 to define the capacitor bottom metal plate. The result is the structure shown in FIG. 3.

Referring to FIG. 4, inter-metal dielectric material is then deposited and planarized (e.g., CMP) to provide an inter-metal dielectric layer 116. Those skilled in the art will appreciate that the thickness of the planarized inter-metal dielectric material 116 will be different over the top and bottom plates of the capacitor. This difference must be taken into account during the subsequent formation of the vias to the capacitor metal plates. The via to the top plate must effectively stop on the top plate and be able to survive an extended over etch while the via to the bottom plate is completely patterned. Of course, if the top via etch selectivity is a problem, then a dual via mask process could be used. In the illustrated embodiment, the thickness of the inter-metal dielectric layer on the capacitor bottom metal is about 6000 Å thick, resulting in a thickness of inter-metal dielectric of about 3300 Å over the capacitor top metal plate.

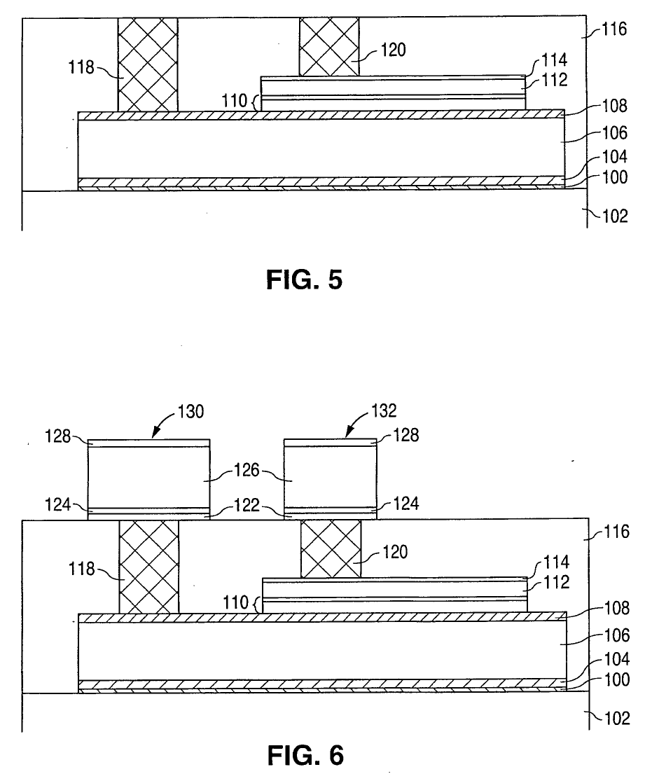

FIG. 5 shows the formation of a Tungsten (W) via 118 through the inter-metal dielectric layer 116 to contact the capacitor bottom metal plate. FIG. 5 also shows the formation of a Tungsten via plug 120 through the inter-metal dielectric layer 116 to contact the capacitor top metal plate.

Finally, as shown in FIG. 6, the top interconnect metal to the capacitor plates is formed by first forming a 100 Å titanium layer 122, followed by a 200A titanium nitride layer 124, an 8500 Å aluminum/copper layer 126 and an upper 250 Å titanium nitride layer 128. This upper interconnect metal layer is then patterned in accordance with conventional processing techniques to form a first top metal contact 130 to the capacitor bottom metal plate and a second top metal contact 132 to the capacitor top metal plate.

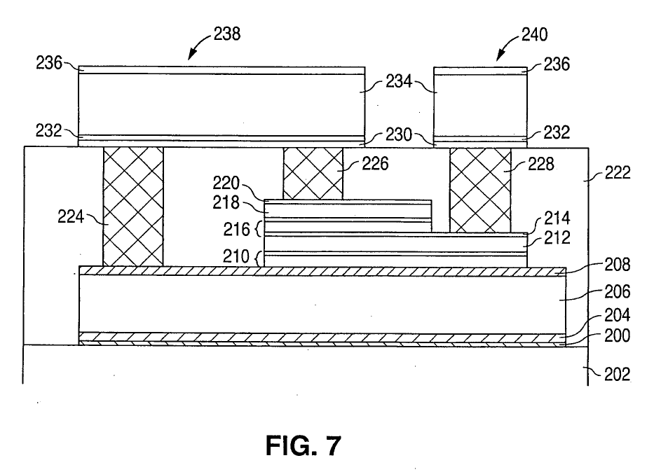

FIG. 7 shows a final device structure for an alternate “double dielectric layer” embodiment of the present invention that provides higher capacitance density than does the FIG. 1-6 embodiment. More specifically, the FIG. 7 embodiment 200 shows a three-plate capacitor structure utilizing two inter-plate dielectric layers, each of which comprises anodized tantalum oxide (in the manner discussed above with respect to the “single dielectric layer” embodiment).

In terms of fabricating the FIG. 7 structure, those skilled in the art will appreciate that the initial steps in the fabrication process are identical to those set forth above with respect to FIGS. 1 and 2. That is, a titanium (Ti) layer 200 about 100 Å thick is formed on a underlying dielectric material layer 202. A titanium nitride (TiN) layer 140 about 200 Å thick is then formed on the underlying titanium layer 200. This is followed by the formation of an aluminum/copper (Al/Cu) layer 206 about 4500 Å thick on the titanium nitride layer 204. A layer of titanium nitride 108 about 250 Å thick is then formed on the aluminum/copper layer 206. As in the above-described embodiment of the invention, these layers will be subsequently patterned to define a capacitor bottom metal plate.

Next, tantalum (Ta) is formed over the upper titanium nitride layer 208 of the “pre” capacitor bottom plate structure. The tantalum layer includes 10-20% nitrogen (N) to facilitate the creation of the appropriate dielectric constant and leakage current for the particular circuit application. Next, an anodization step is performed to convert at least a portion of the TaN to tantalum oxide, typically Ta₂O₅. The result is a titanium (nitrogen) and tantalum oxide layer 210 about 1200 Å thick. This layer 210 provides a first layer of capacitor dielectric material between the yet-to-be-defined capacitor bottom plate and capacitor intermediate metal plate.

Next, as further shown in FIG. 7, an aluminum/copper layer 212 about 1500 Å thick is deposited followed by the formation of a titanium nitride layer 214 about 700 Å thick on the aluminum/copper layer 212, thereby forming the “pre-material” for the capacitor intermediate metal plate.

As stated above, the foregoing fabrication steps are identical to those described above with respect to the FIGS. 1-6 single dielectric layer embodiment of the invention.

With continuing reference to FIG. 7, the process of this “double dielectric layer” embodiment in the invention continues with the formation of a second tantalum layer 216 over the upper titanium nitride layer 214 of the capacitor intermediate metal plate. As in the case of the formation of the first inter-plate dielectric layer 210, the tantalum layer in this case includes 10-20% nitrogen to facilitate the creation of the appropriate dielectric constant and leakage current for the particular circuit application. Next, an anodization step is performed to convert at least a portion of the TaN to tantalum oxide, again typically Ta₂O₅. The result is a tantalum (nitrogen) and tantalum oxide layer 216 about 1200 Å thick. The layer 216 provides the pre-cursor material for a second capacitor inter-layer dielectric between the capacitor intermediate metal plate and a yet-to-be-formed capacitor top metal plate.

Next, an aluminum/copper 218 about 1500 Å thick is deposited followed by the formation of a titanium nitride layer 220 about 700 Å thick on the aluminum/copper layer 218, thereby providing the material for the capacitor top metal plate.

Those skilled in the art will appreciate that, as in the above-described embodiment of the invention, conventional photolithographic pattern and etch steps are then performed in order to define the geometry of the capacitor top metal plate, an underlying layer of capacitor inter-plate dielectric material 216, an intermediate capacitor metal plate, another underlying layer of capacitor inter-plate dielectric material 210, and the definition of the lower capacitor metal plate as described above.

As further shown in FIG. 7, inter-metal dielectric material is then deposited and planarized (e.g., CMP) to provide an inter-metal dielectric layer 222 to insulate the high density capacitor structure. Those skilled in the art will appreciate that the thickness of the planarized inter-metal dielectric material 222 must support three different via heights; that is, the via etch process must take into account the overetch constraints that will occur during the subsequent formation of the via to the capacitor bottom metal plate. In the FIG. 7 embodiment of the invention, the thickness of the inter-metal dielectric layer 222 formed above the capacitor bottom metal plate is about one micron, resulting in a thickness of inter-metal dielectric of about 3400 Å over the capacitor top metal plate.

FIG. 7 also shows the formation of a Tungsten via plug 224 through the inter-metal dielectric layer 222 to contact the capacitor bottom metal plate. FIG. 7 also shows a Tungsten via plug 226 to contact the capacitor top metal plate. Further, FIG. 7 shows a Tungsten via plug 228 through the inter-metal dielectric layer 222 to contact the capacitor intermediate metal plate. Those skilled in the art will appreciate that these three via plugs may be formed in accordance with well known integrate circuit fabrication techniques

Finally, as shown in FIG. 7, the top interconnect metal to the capacitor plates is formed by first forming a 100 Å titanium layer 230, a 200 Å nitride layer 232, an 8500 Å aluminum/copper layer 234 and an upper 250 Å titanium nitride layer 236. This upper interconnect metal layer is then patterned in accordance with conventional processing techniques to form a first metal top contact 238 to both the capacitor bottom metal plate and to the capacitor top metal plate through tungsten vias 224 and 226, respectively. A second top metal contact 240 is formed through tungsten via 228 to the capacitor intermediate metal plate. The resulting “double dielectric layer” high density capacitor structure is shown in FIG. 7.

It should be understood that the particular embodiments of the invention described in this application have been provided by way of example and that other modifications may occur to those skilled in the art without departing from the scope and spirit of the invention as expressed in the appended claims and their equivalents.

What is claimed:

1. A high density capacitor structure comprising:
a capacitor top metal plate;
a capacitor bottom metal plate; and
a capacitor dielectric comprising tantalum oxide formed between the capacitor bottom plate and the capacitor top metal plate.

2. A method of forming a high density capacitor structure, the method comprising:
forming a capacitor bottom metal plate;
forming a layer of capacitor inter-plate dielectric on the capacitor bottom metal plate, the capacitor inter-plate dielectric comprising tantalum oxide; and
forming a capacitor top metal plate on the capacitor inter-plate dielectric.

3. A method as in claim 2, and wherein the step of forming a layer of capacitor inter-plate dielectric comprises:
reactively sputtering Ta in an Argon and Nitrogen ambient to form a layer of TaN; and
performing an anodizing step to convert at least an upper portion of the TaN to tantalum oxide.

4. A method as in claim 3, and wherein the sputtering ambient comprises 10-20% Nitrogen.

5. A method as in claim 3, and wherein the anodizing step is performed using citric acid electrolyte.

6. A high density capacitor structure comprising:
a capacitor bottom metal plate;
a first capacitor inter-plate dielectric formed on the capacitor bottom metal plate, the first capacitor inter-plate dielectric comprising tantalum oxide;
a capacitor intermediate metal plate formed on the first capacitor inter-plate dielectric;
a second capacitor inter-plate dielectric formed on the capacitor intermediate metal plate; and
a capacitor top metal plate formed on the second capacitor inter-plate dielectric material.

7. A high density capacitor structure as in claim 6, and wherein the second capacitor inter-plate dielectric comprises tantalum oxide.

8. A high density capacitor structure as in claim 6, and wherein the first capacitor inter-plate dielectric and the second inter-plate dielectric comprise TaN having a layer of Ta₂O₅ formed thereon.

9. A high density capacitor structure as in claim 8, and wherein the first capacitor inter-plate dielectric and the second capacitor inter-plate dielectric are about 1200 Å thick.
